(19) United States
(12) Patent Application Publication
(10) Pub. No.: US 2016/0074962 A1
(43) Pub. Date: Mar. 17, 2016

(54) METHOD FOR GENERATING A LASER WELD SEAM AND VEHICLE SEAT

(71) Applicant: JOHNSON CONTROLS COMPONENTS GMBH & CO. KG, Kaiserslautern (DE)

(72) Inventor: Michael KOENIG, Rodenbach (DE)

(21) Appl. No.: 14/786,700

(22) PCT Filed: Apr. 8, 2014
(86) PCT No.: PCT/EP2014/057024

§ 371 Date: Oct. 23, 2015

(30) Foreign Application Priority Data
Apr. 25, 2013 (DE) 10 2013 207 541.3

(51) Int. Cl. B23K 26/08; B60N 2/68; B23K 26/26

(52) U.S. Cl. CPC B23K 26/08; B23K 26/26; B60N 2/682

(57) ABSTRACT

A method for generating a laser weld seam (40) with a laser beam for connecting two essentially planar objects (20, 30). The essentially planar objects (30) can firstly be placed in contact with one another and then connected to one another in a welding process. The energy of the laser beam penetrates through one of the planar objects (30) into the other planar object (20).

The laser weld seam (40) includes at least one pendulum region (46, 48) in which the laser beam is guided in a pendulum movement about a welding axis (A), and at least one central region (50) in which the laser beam is guided at least approximately linearly along the weld axis (A). A vehicle seat (1) which includes at least one laser weld seam (40) is generated according to the method.

### CROSS REFERENCE TO RELATED APPLICATIONS

This application is a United States National Phase Application of International Application PCT/EP2014/057024 filed Apr. 8, 2014 and claims the benefit of priority under 35 U.S.C. §119 of German Patent Application 10 2013 207 541.3 filed Apr. 25, 2013 the entire contents of which are incorporated herein by reference.

### FIELD OF THE INVENTION

The invention relates to a method for generating a laser weld seam with a laser beam, for connecting two substantially planar objects, wherein the substantially planar objects are initially brought into contact with one another and then are connected to one another in a welding process, wherein the energy of the laser beam penetrates through the one planar object into the other planar object. The invention also relates to a seat having at least one laser weld seam which is generated according to the method.

### BACKGROUND OF THE INVENTION

Components and structures of motor vehicle seats, for example longitudinal adjusters, substructures and backrests, are frequently made up of a plurality of individual components which are connected together by means of laser welding.

In this case, the energy of a laser beam penetrates through one planar component into another component, whereby local heating of the two components takes place at the contact point of the two components and the components are welded together.

A generic method for producing a laser weld seam is disclosed in DE 196 27 913 A1. Laser weld seams produced thereby on bodywork components have a central region extending in a linear manner and in the end regions are designed to be reinforced, in particular thickened, widened, secured or bent back. As a result, the strength of a laser weld seam thus produced is increased relative to a laser weld seam extending entirely in a linear manner.

A method for producing a weld seam is disclosed in DE 10 2009 052 220 A1, said weld seam comprising a linear region and a round or droplet-shaped region adjacent thereto.

A method for connecting a plurality of planar metal sheets by means of oscillating weld seams is disclosed in DE 10 2005 001 606 A1.

A method for connecting a plurality of planar metal sheets by means of oscillating weld seams is also disclosed in DE 10 2007 063 456 A1.

### SUMMARY OF THE INVENTION

An object of the invention is to provide an alternative method for generating a laser weld seam of the type mentioned in the introduction, wherein the laser weld seams which have been generated have greater strength relative to a laser weld seam extending entirely in a linear manner. An object of the invention is also to provide a vehicle seat which has a laser weld seam with correspondingly increased strength.

In a generic method for generating a laser weld seam by means of a laser beam for connecting two substantially planar objects, the substantially planar objects are initially brought into contact with one another and then are connected to one another in a welding process, wherein the energy of the laser beam penetrates through the one planar object into the other planar object.

According to the invention, it is provided in this case that the laser weld seam comprises at least one oscillating region in which the laser beam is guided in the form of an oscillating motion about a welding axis and at least one central region in which the laser beam is guided in an at least approximately linear manner along the welding axis.

By means of the method according to the invention a laser weld seam is generated, said laser weld seam, on the one hand, having a relatively high degree of strength in the oscillating region and, on the other hand, being able to be generated in the central region in a relatively short processing time. Preferably, in this case the laser weld seam is arranged and oriented such that the oscillating region is located at a region of the greatest anticipated load. The process time is understood as a period of time which is required for generating the laser weld seam by means of the laser beam.

Preferably, just two oscillating regions are provided, namely a start region and a finish region.

Preferably, the central region is arranged between the start region and the finish region.

The method according to the invention is able to be used particularly advantageously in the manufacture of a backrest of a vehicle seat, wherein the substantially planar objects to be welded are a backrest frame and a backrest panel of a backrest.

According to one advantageous embodiment of the invention, the laser beam repeatedly crosses the welding axis during the oscillating motion in the oscillating region.

Advantageously, the amplitude of the oscillating motion is altered at the same time. As a result, in a region in which an increased load is to be anticipated, a greater amplitude may be selected, whereby the strength is increased. In a region in which a reduced load is to be anticipated, a smaller amplitude may be selected, whereby the process time is reduced.

Preferably, the amplitude of the oscillating motion has a maximum value at a start point and/or a finish point of the oscillating region remote from the central region and thus also of the laser weld seam.

At the transition from the oscillating region to the central region the amplitude of the oscillating motion is preferably approximately zero or equal to zero.

Particularly advantageously, the laser weld seam has a length factor, which corresponds to the ratio of the extended length to the linear length, of approximately 1.2 to 1.3, preferably approximately 1.25. The extended length of the laser weld seam corresponds in this case to the path which the laser beam covers when generating the laser weld seam. The linear length of the laser weld seam is the distance between the start point of the laser weld seam remote from the central region and the finish point of the laser weld seam remote from the central region. A length factor of 1.2 to 1.3, preferably approximately 1.25, ensures a relatively high degree of strength of the laser weld seam, with at the same time a relatively short processing time.

The at least one oscillating region, for example the start region or the finish region, preferably has a length factor, which corresponds to the ratio of the extended length to the linear length, of approximately 1.8 to 2.0. The extended length of the oscillating region in this case corresponds to the path which the laser beam covers when generating the oscillating region. The linear length of the oscillating region is the distance between the start point or the finish point of the oscillating region remote from the central region and the transition from the central region to the oscillating region.

The ratio of the linear length of the at least one oscillating region to the linear length of the central region advantageously corresponds approximately to a value of 0.2 to 0.25. The linear length of the central region in this case is the extent of the central region along the welding axis.

In the central region the laser weld seam preferably has an extent perpendicular to the welding axis of approximately 0.6 mm to 0.8 mm, preferably approximately 0.7 mm.

According to another aspect of the invention, a vehicle seat comprising at least one laser weld seam which is generated according to the method according to the invention.

The invention is described in more detail hereinafter with reference to an advantageous exemplary embodiment shown in the figures. The invention is not limited, however, to this exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the embodiment of the invention is illustrated.

### BRIEF DESCRIPTION OF THE DRAWINGS

In the drawings:

FIG. 1 is a schematic view of a vehicle seat;

FIG. 2 is a perspective view of a seat structure of a vehicle seat; and

FIG. 3 is a laser weld seam which is produced by the method according to the invention.

### DESCRIPTION OF THE PREFERRED EMBODIMENTS

A vehicle seat 1 for a motor vehicle, in the present case a rear seat, has a seat part 3 and a backrest 4 which is attached thereto and which may be adjusted in terms of inclination. The vehicle seat could, however, also be a front seat. The backrest 4 could also be rigidly connected to the structure of the vehicle.

The vehicle seat 1 comprises a seat structure 10 which substantially consists of metal and which is upholstered with foam parts. The seat structure 10 and the foam parts are covered by a cover which consists, for example, of leather or fabric. The foam parts and the cover considerably increase the seating comfort for an occupant of the vehicle seat 1.

The arrangement of the vehicle seat 1 inside the vehicle and the usual direction of travel thereof define the directional information used hereinafter. In this case a direction oriented perpendicular to the ground is denoted hereinafter as the vertical direction and a direction perpendicular to the vertical direction and perpendicular to the direction of travel is denoted hereinafter as the transverse direction. The vertical direction also encloses an angular range relative to the direction oriented perpendicular to the ground, in which the backrest 4 is located in the usual position of use.

By means of a backrest adjustment fitting 19 arranged to the side and able to be operated manually, the backrest 4 is able to be adjusted in terms of inclination, which means that the angle between the seat part 3 and the backrest 4 is able to be adjusted. Alternatively, an electrical drive is also conceivable. With an adjustment of the inclination, the backrest 4 pivots about a pivot axis 12 extending in the transverse direction.

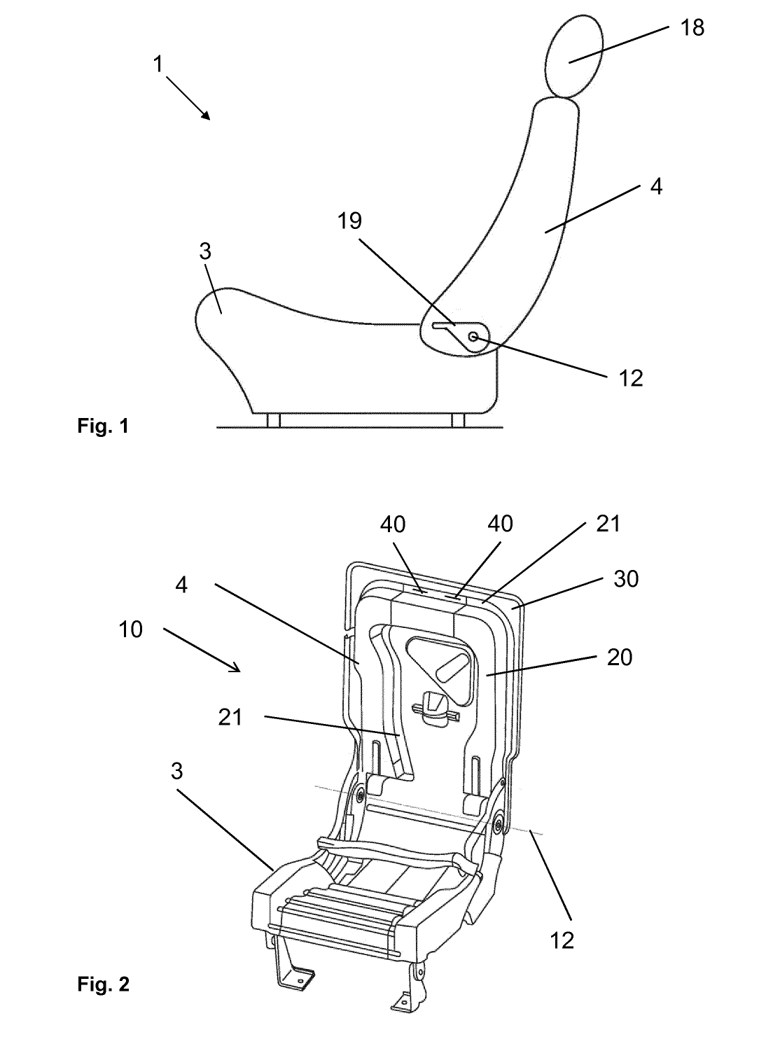

In the views according to FIG. 1 and FIG. 2, the backrest 4 is in its position of use and thus extends in the vertical direction. A headrest 18 is attached to the upper end of the backrest 4 which is remote from the seat part 3 in the vertical direction, said headrest being adjustable in terms of height and inclination.

The backrest 4 comprises, amongst other things, a backrest frame 20 and a backrest panel 30 which is configured as a planar object. The backrest panel 30 may contain reinforcing ribs or beads but is nevertheless regarded as planar.

The backrest frame 20 is designed in the present case as a partially peripheral profile. The profile has an approximately U-shape cross section with two limbs extending in parallel and a base connecting the limbs. In each case a flange 21 is provided at the ends of the limbs remote from the base, said flange extending parallel to the base. The base and the flanges 21 in each case are of planar configuration and extend at right angles to the two limbs.

The backrest panel 30 and the backrest frame 20 consist in the present case of metal, in particular of steel, and are connected together by means of a plurality of laser weld seams 40. In FIG. 2 two such laser weld seams 40 are shown, but generally more than two laser weld seams 40 are present.

When producing the backrest 4 of the seat structure 10 of the vehicle seat 1, the backrest panel 30 and the backrest frame 20, amongst other things, are connected together by means of laser welding.

To this end, the backrest panel 30 and the backrest frame 20 are positioned relative to one another and pressed against one another in a device provided therefor. Thereafter, the flanges 21 which protrude from the limbs of the profile of the backrest frame 20 bear in a planar manner against the backrest panel 30. Said flanges 21 and the base extend, therefore, parallel to the backrest panel 30 and the limbs of the profile of the backrest frame 20 extend perpendicular to the backrest panel 30.

Subsequently the flanges 21 and the backrest panel 30 are connected together by means of laser welding, wherein the energy of a laser beam penetrates through the backrest panel 30 into the flanges 21 of the backrest frame 20. In this case, the laser beam is oriented toward the backrest panel 30 and generates a laser weld seam 40 which is visible there. After a plurality of laser weld seams 40 have been generated on the backrest panel 30, the backrest panel 30 is connected to the backrest frame 20 by means of laser welding.

For generating such a laser weld seam 40, the laser beam is initially oriented toward a start point 42. From there the laser beam is guided over the surface of the backrest panel 30 as far as a finish point 44 and thus produces the laser weld seam 40 on its path thereto. The laser weld seam 40 extends, therefore, between the start point 42 and the finish point 44.

The laser beam moves primarily in a welding direction S when the laser weld seam 40 is generated.

Starting at the start point 42, the laser beam initially also performs an oscillating motion perpendicular to the welding direction S. Thus, an oscillating seam is generated in a start region 46 of the laser weld seam 40 which, starting at the start point 42, extends in the welding direction S in the direction of the finish point 44.

After passing through the start region 46, the laser beam exclusively moves in a linear manner in the welding direction S and thus generates a linear seam in a central region 50.

After passing through the central region 50, the laser beam moves further in the welding direction S and additionally performs an oscillating motion perpendicular to the welding direction S. Thus, a further oscillating seam is produced in a finish region 48 of the laser weld seam 40, said finish region extending in the welding direction S as far as the finish point 44.

The laser weld seam 40 thus comprises a start region 46, a finish region 48 and a central region 50 located therebetween, wherein the central region 50 has a linear seam and the start region 46 and the finish region 48 in each case have an oscillating seam. The start region 46 and the finish region 48 are also denoted as oscillating regions. The start point 42 and the finish point 44 of the laser weld seam 40 in this case are respectively located at the edge of the laser weld seam 40 remote from the central region 50.

In the present case, the amplitude of the oscillating motion of the laser beam is altered in the start region 46 and in the finish region 48. It is also conceivable, however, for the amplitude of the oscillating motion to remain constant in the start region 46 and/or in the finish region 48.

Starting at the start point 42, the amplitude of the oscillating motion has a maximum value and reduces along the start region 46. At the transition from the start region 46 to the central region 50, the amplitude of the oscillating motion is then equal to zero and the oscillating motion is thus terminated.

At the transition from the central region 50 to the finish region 48, the amplitude of the oscillating motion is still equal to zero. Starting at the transition from the central region 50 to the finish region 48, the oscillating motion starts again and the amplitude of the oscillating motion increases at the same time. When the finish point 44 is reached, the amplitude of the oscillating motion again has a maximum value.

During the oscillating motion in the start region 46 and in the finish region 48 the laser beam repeatedly crosses a welding axis A. The welding axis A is a straight line which extends in the direction of the welding direction S and centrally through the central region 50.

In the present case, the start point 42 and also the finish point 44 are located on the welding axis A. However, it is also conceivable for the start point 42 and/or the finish point 44 to be located laterally offset to the welding axis A.

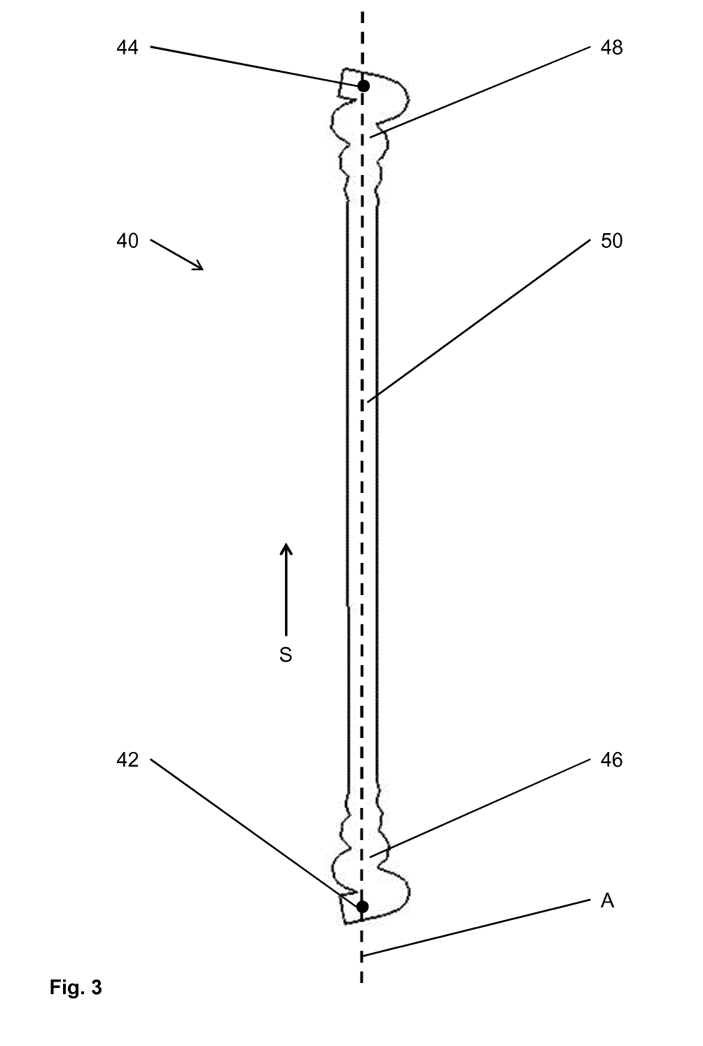

The laser weld seam 40 shown in FIG. 3 in the present case has a linear length of approximately 20 mm. The linear length of the laser weld seam 40 is the distance between the start point 42 and the finish point 44. In the present case the extended length of the laser weld seam 40, which corresponds to the path covered by the laser beam, is approximately 25 mm.

Thus, in the present case a length factor, which corresponds to the ratio of the extended length to the linear length, of approximately 1.25 is produced. The extended length of the laser weld seam 40 is thus approximately 25% greater than the linear length.

The linear length of the start region 46, which corresponds to the distance between the start point 42 and the start of the central region 50, is in the present case approximately 3 mm. Also the linear length of the finish region 48, which corresponds to the distance between the finish point 44 and the end of the central region 50, is in the present case approximately 3 mm. The length of the central region 50 in the present case is approximately 14 mm.

Other dimensions of the linear lengths of the laser weld seam 40 and the start region 46 and the finish region 48 are also conceivable, as are other dimensions of the extended length of the laser weld seam 40 and the length of the central region 50.

The features disclosed in the above description, the claims and the drawings may be significant for implementing the invention in the various embodiments thereof, both individually and in combination with one another.

While specific embodiments of the invention have been shown and described in detail to illustrate the application of the principles of the invention, it will be understood that the invention may be embodied otherwise without departing from such principles.

1. A method for generating a laser weld seam with a laser beam, for connecting two substantially planar objects, the method comprising the steps of:
bringing the substantially planar objects into contact with one another; and
connecting the brought together planar objects to one another in a welding process, wherein the energy of the laser beam penetrates through the one planar object into the other planar object to generate the laser weld seam that comprises at least one oscillating region formed by guiding the laser beam in the form of an oscillating motion about a welding axis and at least one central region formed by guiding the laser beam at least approximately in a linear manner along the welding axis.

2. The method as claimed in claim 1, wherein just two oscillating regions are provided comprises of a start region and a finish region.

3. The method as claimed in claim 2, wherein the central region is arranged between the start region and the finish region.

4. The method as claimed in claim 1, wherein the substantially planar objects are a backrest frame and a backrest panel of a backrest of a vehicle seat.

5. The method as claimed in claim 1, wherein the laser beam repeatedly crosses the welding axis during the oscillating motion in the oscillating region.

6. The method as claimed in claim 1, wherein the amplitude of the oscillating motion is altered.

7. The method as claimed in claim 6, wherein the amplitude of the oscillating motion has a maximum value at a start point of the oscillating region remote from the central region.

8. The method as claimed in claim 6, wherein the amplitude of the oscillating motion has a maximum value at a finish point of the oscillating region remote from the central region.

9. The method as claimed in claim 6, wherein at a transition from the oscillating region to the central region the amplitude of the oscillating motion is equal to zero.

10. The method as claimed in claim 1, wherein the laser weld seam has a length factor, which corresponds to a ratio of an extended length to a linear length, of approximately 1.2 to 1.3.

11. The method as claimed in claim 1, wherein the laser weld seam has a length factor, which corresponds to a ratio of an extended length to a linear length, of approximately 1.25.

12. The method as claimed in claim 1, wherein the at least one oscillating region has a length factor, which corresponds to a ratio of an extended length to a linear length, of approximately 1.8 to 2.0.

13. The method as claimed in claim 1, wherein the ratio of a linear length of the at least one oscillating region to a linear length of the central region corresponds approximately to a value of 0.2 to 0.25.

14. The method as claimed in claim 1, wherein in the central region the laser weld seam has an extent, perpendicular to the welding axis, of approximately 0.6 mm to 0.8 mm.

15. A vehicle seat comprising at least one laser weld seam which is generated by the method comprising:
providing two substantially planar vehicle seat part objects;
bringing the substantially planar objects into contact with one another; and
connecting the brought together planar objects to one another in a welding process, wherein the energy of the laser beam penetrates through the one planar object into the other planar object to generate a laser weld seam that comprises at least one oscillating region formed by guiding the laser beam in the form of an oscillating motion about a welding axis and at least one central region formed by guiding the laser beam at least approximately in a linear manner along the welding axis.

16. The vehicle seat as claimed in claim 15, wherein:
just two oscillating regions are provided comprising a laser weld seam start region and a laser weld seam finish region; and
the central region is arranged between the start region and the finish region.

17. The vehicle seat as claimed in claim 16, wherein the substantially planar objects are a backrest frame and a backrest panel of a backrest of a vehicle seat.

18. A vehicle seat comprising:
a first vehicle seat object with at least one first object substantially planar portion;
a second vehicle seat object with at least one second object substantially planar portion;
at least one laser weld seam connecting the first object substantially planar portion to the second object substantially planar portion, the at least one laser weld seam comprising at least one oscillating region formed, subsequent to bringing the first object substantially planar portion together with the second object substantially planar portion, by guiding a laser beam in a form of an oscillating motion about a welding axis and at least one central region formed by guiding the laser beam at least approximately in a linear manner along the welding axis, wherein energy of the laser beam penetrates through the first object substantially planar portion to the second object substantially planar portion to generate the laser weld seam.

19. The vehicle seat as claimed in claim 16, wherein the first vehicle seat object comprises a backrest frame and the second vehicle seat object comprises a backrest panel of a backrest of a vehicle seat.

20. The vehicle seat as claimed in claim 19, wherein:
just two oscillating regions are provided comprising a laser weld seam start region and a laser weld seam finish region; and
the central region is arranged between the start region and the finish region.
